(19) United States
(12) Patent Application Publication
(10) Pub. No.: US 2003/0061085 A1
(43) Pub. Date: Mar. 27, 2003

(54) Air travel system with decoupled baggage

(76) Inventor: John Lanigan SR., Orland Park, IL (US)

Correspondence Address: George H. Gerstman, SEYFARTH, SHAW, 55 East Monroe Street, Chicago, IL, 60603, US

(21) Appl. No.: 09/957,989

(22) Filed: Sep. 21, 2001

(51) Int. Cl. G06F 17/60

(52) U.S. Cl. 705/8

(57) ABSTRACT

A method of providing passenger air travel comprises the following: an airline flight reservation is provided for a passenger, and, simultaneously, a reservation for pickup of the passenger's luggage at a location remote from the airport from which the flight originates, said pickup reservation also specifying a luggage destination. An airline flight is provided for the passenger from the airport to a pre-arranged airport destination. Transportation is also provided of the luggage by different transportation from the remote location to the luggage destination.

### BACKGROUND OF THE INVENTION

Recent events have highlighted the known difficulties for airlines of consistently providing profitable passenger air transport. Profit margins are thin, and highly vulnerable to any sort of slowdown.

One major cost for an airline is baggage handling. The cost is high for baggage handling personnel, for the valuable real estate space that is required at the airport for baggage handling, and because the delays that are created by the necessary baggage loading and unloading of airlines. Delays in flight for an airliner can result in a cost of $100 a minute and more. Furthermore, misdirected bags provide additional substantial cost to the airline, estimated at $100 per bag. The baggage handling system, even when running well, inherently slows the turnaround time of airliners, imposing added costs on airline companies above and beyond the high direct baggage handling expenses.

Furthermore, the heavyweight of passenger luggage can restrict the number of passengers on an airline, and can take up room which otherwise could be sold as air freight for added income.

Particularly with larger aircraft such as the Boeing 747, the baggage handling process of a full airliner can approach nightmare proportions, resulting in an inherent delay of the next flight for the airline and also resulting in great cost, as well as serious inconvenience to the passengers.

By this invention, a passenger air transport system is provided, having great improvement of efficiency and reduction of cost when compared with current systems. This invention is expected to enhance safety in the airlines' overall operations; expedite the airline passengers' transit into and out of the airport; dramatically reduce airline baggage costs and consequently reduce airline passengers' fares; increase aircraft utilization of passenger seats; reduce the turnaround time of airlines, (that is the minimum possible time between arrival and departure); increase the profitability of the airline industry; reduce the cost of rebuilding present and future airline terminals, (which are necessarily inevitable due to the increase in passengers); eliminating congestion at the arrival and departure curbs of the airline terminal concourses; reduce complaints of lost and misdirected baggage to the airlines; increase air cargo revenue; increase aircraft utilization as well as improving utilization of the infrastructure of airspace, runways, building, control tower, etc.; and significantly make air travel more pleasant for the passenger.

### DESCRIPTION OF THE INVENTION

Basically, the invention of this application relates to the concept of decoupling most passenger baggage from the passenger, so that the baggage of the passenger may travel in a different way from the passenger. Specifically, such baggage may never be within the physical control of the airline passenger flight personnel, but maybe handled from pickup through delivery by a separate express package handling company such as Federal Express, the United Parcel Corporation, or a subsidiary of the Airline. The baggage may be picked up at the passenger's home or other desired location, and it may be delivered at the passenger's actual destination, so that the baggage may never even pass through the airline passenger terminal, but is handled through an efficient, separate package delivery system, several of which are already in existence.

While carry-on baggage might be taken on board aircraft by the passengers, and special, premium baggage might travel on the same airplane as extra cost air freight, this invention would result in a reduction of the airline baggage handling, cost, and liability by one or more orders of magnitude, while providing comfort for the passenger. Long baggage check-in lines would be eliminated. The effort of lugging the luggage would be a thing of the past. The vast, baggage handling enterprise required to be maintained by airlines at the passenger terminal could be greatly reduced. The space saving achieved by the airlines can then provide available space for urgent air cargo, providing additional income for the airlines.

Specifically, by this invention a method is provided for passenger air travel which comprises: providing an airline flight reservation for the passenger and, simultaneously, providing a reservation for pickup of the passenger's luggage at a location remote from the airport from which the flight originates. The pickup reservation also specifies a luggage destination. By this invention, the reservation for pickup of the passenger's luggage at his home or any other specified location would be an integral part of an otherwise conventional airline flight reservation. The price of baggage pickup would be part of the airline reservation and, typically, would not be broken out as a separate price. The luggage destination, which would be another home, hotel, or any desired location, typically away from the airport, would also be specified along with the rest of the airline flight reservation.

The airline flight is then provided for the passenger from the airport to a prearranged airport destination: for example, from Chicago's O'Hare Field to the Denver airport, or from any commercial airport to another commercial airport. Transportation of the luggage is provided by different transportation from the remote location of luggage pickup to the luggage destination, both of which may be private homes, or any other location or destination, typically remote from a commercial airport.

As stated above, the luggage handling can then be provided by a commercial package delivery organization, which receives the order from the airline when the flight reservation is made. It is also expected to be normal for the luggage to be picked up at an earlier period of time prior to the passenger's flight, for delivery at the luggage destination at a time approximating the passenger's arrival at the luggage destination, which of course may be substantially after the passenger's arrival at the airport destination. Accordingly, it can be seen that the luggage may take a very different route from the passenger. For example, with Federal Express, most of their packages pass through Memphis, irrespective of the ultimate destination, but could arrive at the ultimate destination approximately at the same time as the passenger or earlier, especially if the luggage is picked up a day early, because the process can continue on through the night, prior to the passenger even boarding the airplane.

The remote location from which the luggage is picked up may comprise a lockable luggage container situated outside of a private home. This would be a good aspect of the invention, particularly for frequent fliers, who would merely deposit the luggage in the locked luggage container. The luggage would then be picked up by the luggage carrier, who has master key access to the container. Delivery to a similar lockable luggage container is also an advantageous feature in many circumstances, if the delivery is also to a private home. Thus a homeowner does not have to stay home, awaiting luggage pick-up or delivery.

For sorting and handling of the luggage as it is transported, each piece of luggage may carry an attached radio frequency identification (RFID) chip. This well-known technology, available from Motorola Corporation and elsewhere, can greatly facilitate the handling the luggage. As is common in the current express package delivery industry, the status and location of each piece of luggage can be determined at any time after the luggage has entered the system. Other automated identification systems may also be used, such as barcode systems.

Transportation of the luggage can also be provided, at least in part, by a vehicle which is capable of loading luggage in a random manner, and then unloading luggage in a manner that is automatically sorted by destination or other characteristic. This technology in a vehicle may resemble a present dry-cleaning storage system, which includes an endless loop moving rack which carries the dry cleaning, with desired dry cleaning being brought forward for delivery as it is called for. In similar manner, luggage for the various cities and destinations can be sorted for delivery even while proceeding with the transportation, for great efficiency of operation.

The passenger is typically provided prior to the flight with a printed record of the flight reservation and the luggage pickup reservation, which reservation lists a tracking code for each piece of luggage in a manner similar to the technology of present-day package delivery organizations.

Also, when airports no longer require the large utilization of space for baggage handling, other uses may be made of the space, such as increased space for other airline operations and for shopping opportunities for passengers as they await for their flight. If a purchase is made, the item purchased may be assigned a tracking code which is at least related to the tracking code assigned to a piece of the passenger's luggage. The purchased item can be blended into the delivery system, and delivered to the luggage destination along with the luggage. Large supplies of the item purchased do not even need to be at the airport where the purchase is made. Part of the system may include the sending of the order to a warehouse which is nearby the luggage destination, for delivery from that location to the luggage destination along with the passenger's luggage.

### DESCRIPTION OF DRAWINGS

Referring to the drawings, FIG. 1 is a pictorial flow chart of an embodiment of a method of this invention.

FIG. 2 is a pictorial view of baggage being loaded from a baggage transport and sorting vehicle to a cargo airplane in accordance with this invention, or vice versa.

FIG. 3 is a plan view of the interior of a baggage transport and sorting vehicle trailer.

FIG. 4 is an elevational view of the interior of the transport and sorting trailer of FIG. 3.

FIG. 5 is an end view of the transport and sorting trailer interior of FIGS. 3 and 4.

FIG. 6 is a fragmentary elevational view of a baggage indicia reading apparatus which may be used in the invention of this application.

### DESCRIPTION OF THE SPECIFIC EMBODIMENTS

Referring to the drawings, FIG. 1 shows a typical process in accordance with this invention. As exemplified by step 1 of FIG. 1, the passenger makes a conventional reservation with an airline company, preferably more than 24 hours in advance of the flight. The usual facts which are picked up in an airline reservation are taken, but also the customer provides special instructions on when and where to pick up the baggage and when and where to deliver it, both the baggage pickup and delivery points being typically away from the airport.

In step 2, the airline representative transmits the information received from the passenger and other necessary information, including flight number, address of baggage pickup and delivery, etc. to the central office of the luggage carrier, which comprises a different system from the airline passenger carrier system, for example, United Parcel, Federal Express, or another organization, possibly a subsidiary of the airline.

In step 3 of FIG. 1, the luggage carrier's central office 21 receives the information, and prints radio frequency ID tags (RFID tags) for attachment to the bag. A pickup and delivery route is automatically arranged, depending on the schedule of luggage in a given area to be picked up and delivered. Baggage carrier vehicle 20 moves on its way to pick up passenger luggage.

In step 4, the luggage is preferably placed in an outside container 22, which is locked by the homeowner, but to which the operator of baggage carrier vehicle 20 has access either through a master key, electronic access, or the like.

In step 5, the luggage bags 24 are tagged with their RFID tags 64, which may be stuck to the bag in a permanent manner and subsequently re-used. As indicated in step 6, the luggage 24 is loaded onto the baggage delivery truck 20. In step 7 of FIG. 1, the luggage 24 is unloaded from truck 20 to a central distribution/sorting facility 26. It may be sorted by an appropriate automatic sorting system based upon the information carried on the RFID tags, and thus passed by conveyer 28 to a specific cargo plane 30, as in step 8 of FIG. 1. Alternately, the cargo may be transported by cargo carrier and sorted on the carrier or in a central, national or regional sorting area such as the Memphis, Tennessee facility of Federal Express. Alternatively, bags or luggage 24 may be sorted and placed on a truck for ground transportation to nearer destinations of typically 500 miles or less.

In this specific embodiment, in step 9 air cargo plane 30 descends to a destination airport. At the airport, in step 10, the luggage 24 may be conveyed to a local distribution/sorting facility 32 and then to a luggage carrier 34 for individual delivery to the desired destination away from the airport. Alternatively, the luggage 24, having been pre-sorted, may be distributed by a direct conveyer 38 to a luggage carrier 34, which will receive luggage for delivery in a local area, including hotel 40 or other destination as indicated in step 11, and as governed by the radio frequency ID tags. A locked delivery container 42 maybe used at the luggage destination as well as at the pickup point 22, as may be appropriate, so that the baggage delivery person is not dependent upon getting in touch with a person at either the luggage pickup or the delivery destination 22,42. The luggage may be simply inserted into container 42 and relocked for pickup at the convenience of the customer at destination 40. At a hotel or the like, luggage delivery may be directly to a hotel employee.

Preferably, during the period between step 4 and step 11 of FIG. 1, the passenger proceeds to the airport, generally with a small carry-on bag if desired, and, preferably without any baggage checking, the passenger enters the airliner and is conveyed to the desired airport destination. From there the passenger makes his or her way in normal manner to the ultimate destination 40. Typically, luggage 24 will already be present in container 42, or will arrive in short order. The luggage pickup of step 4 preferably takes place about a day prior to the passenger's travel date.

The passenger airlines are thus freed from a great amount of weight to transport, which makes it possible for them to fill the airliner with passengers, and also to fill the airliner with priority air freight, for which additional income can be earned by the airline.

By this technique, fewer flights from congested, major airports may take place, in that the baggage delivery airplanes 30 may depart from a less-used airport outside of the extreme congestion of the current, major urban airports. Alternatively (or also), baggage delivery flights 30 can depart and arrive in the small hours of the morning when even the major, congested airports are not busy.

Airline turnaround time of passenger aircraft can be greatly reduced in this manner, and the grave logistical complexities among thousands of passengers can be significantly reduced. The more rapid turnaround of airliners can result in a need for fewer airliners, resulting in an astronomical saving of capital.

Also, this simplification of baggage handling can render more practical the creation of airline alliances in the United States of a type that now takes place in international air travel. To address the problem of airport congestion in major airports, more flights may be served by large airplanes (jumbo jets), in which various airlines share the expenses of the larger airliner and separately sell tickets for air travel on such shared airlines. By this means, load factors can rise on the individual airliners, and the number of airliners traveling, say from Chicago to Detroit on a given day, can be reduced, since the same number of passengers, purchasing tickets from perhaps four different airlines, can be carried on fewer, shared planes, resulting in fewer daily flights without a loss of seat-mile capacity. This can be accomplished when the baggage problem is eliminated, each airline arranging for the separate transport of most passenger baggage in the manner of this invention.

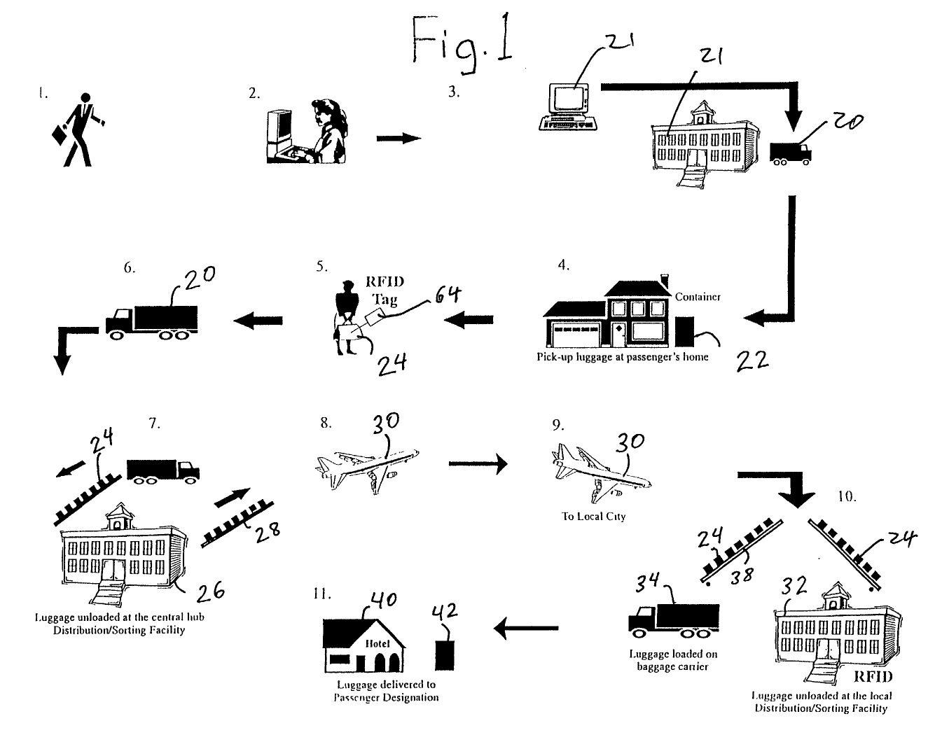

Referring to FIG. 2, a baggage transfer technique is shown, pertaining to the sorting of baggage while transport is taking place. As specifically shown, baggage from baggage hauling truck 20 is passing in the conveyer 23 to baggage airplane 30. The baggage has been previously sorted, optionally in truck 20 itself by destination, for example Detroit, South Bend, and Grand Rapids. Thus, the baggage can be dropped off or otherwise distributed in an efficient, blocked, manner when baggage airplane 30 reaches its destination.

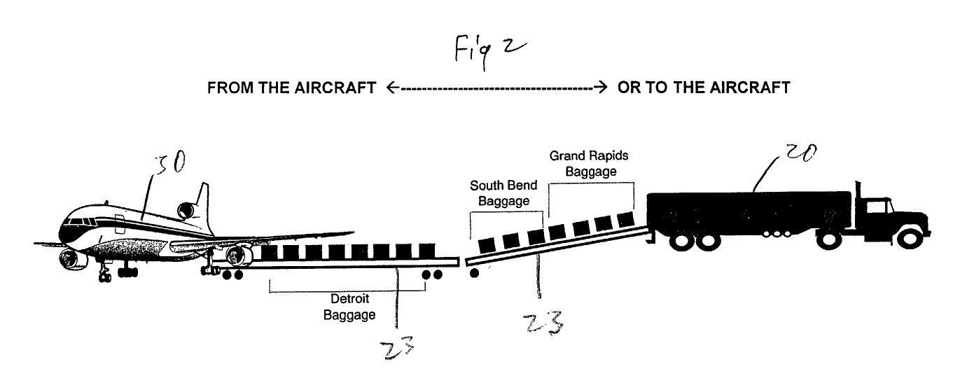

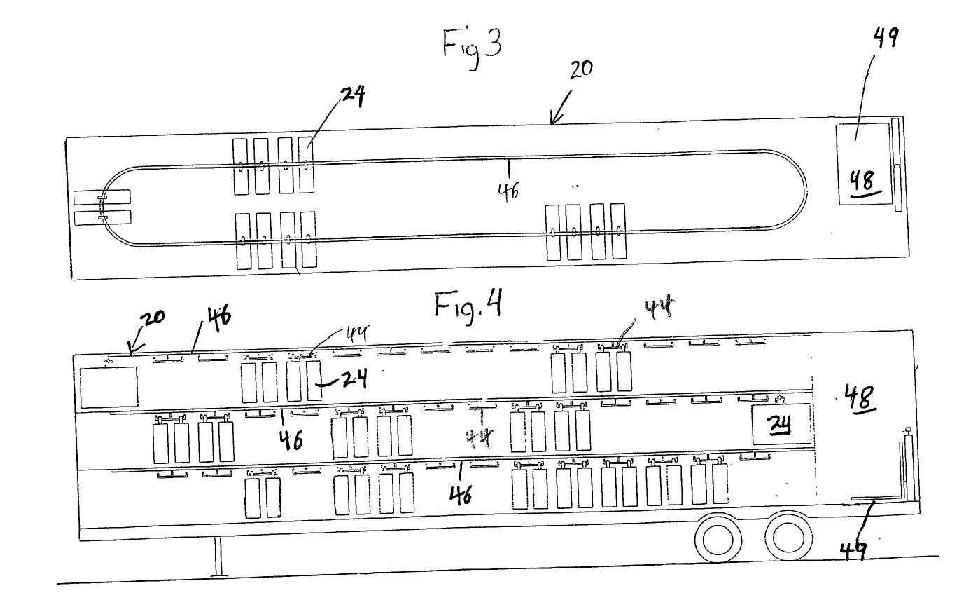

FIGS. 3-5 show one example of how baggage might be handled and sorted in baggage truck 20. The baggage is of course picked up in a manner which is not systematic with respect to its destination, as the truck goes from home to home and hotel to hotel to pick up passengers' bags 24. Bags 24 hang from brackets 44 which are capable of being moved on a circular path along a loop-shaped track 46, so that any desired bag may be presented at the rear loading area 48 of truck trailer 20, which includes a baggage and man lift 49. It can be seen that three separate tracks 46 are provided on three separate levels for the respective luggage 24. Each of these looped tracks 46 are similar in concept to structure found in dry-cleaning establishments, which have the same capability of moving the dry cleaning on a loop-shaped track to bring desired dry cleaning forward.

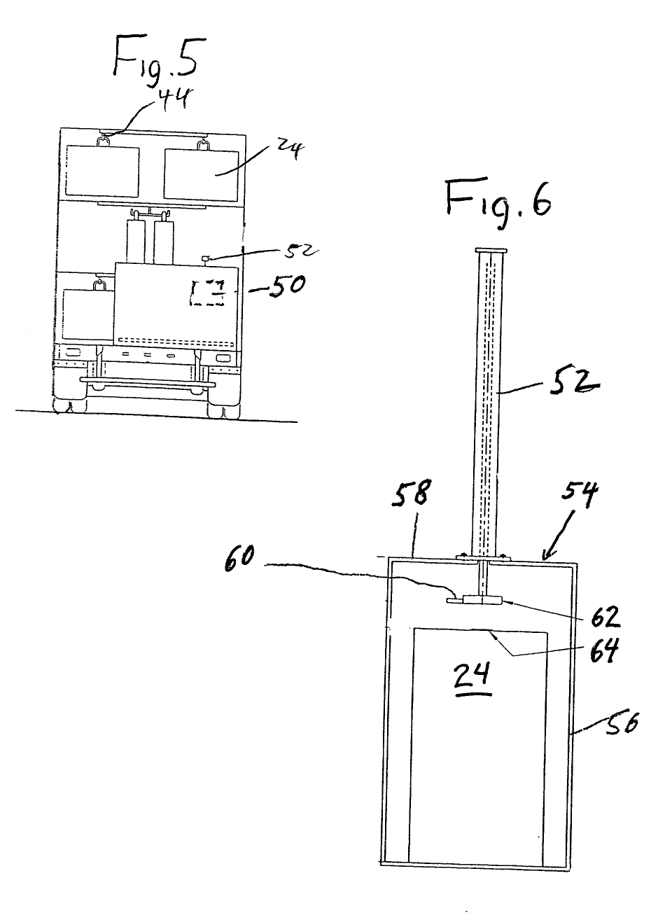

A computer 50 (FIG. 5) may be provided, as well as a radio frequency reader 62 for reading RFID tags of the bags as they are loaded, typically in a random manner from the pickup points 22. Then, when delivery truck 20 reaches its initial destination, bags 24 may unloaded in an order as determined by computer 50, moving the respective brackets 44 along tracks 46 to present the respective bags 24 in a rational order for loading and/or delivery in a manner shown in FIG. 2. Thus, sorting can be automatic, for substantial time savings. The same process may work in reverse as bags are selectively unloaded from airplane 30 to a delivery truck 34 in a rational order to facilitate delivery. Alternatively, the bags may be delivered from a truck 20 in random manner at a sorting facility, where the RFID tags will cause the facility to direct them in a desired direction of sorting, for efficient, quick delivery.

Referring particularly to FIG. 6, a device for sorting the respective luggage items 24 is shown. Sorter 54 comprises a chamber 56, and a hydraulic cylinder 52 extending through the top wall 58 of chamber 56. As baggage 24 passes through chamber 56 on a conveyer belt or the like, an electric eye 60 notices its presence, and a reader 62 is activated to read RFID tag 64. Electric eye 60 and reader 62 may be moved up and down by the hydraulic, telescoping cylinder as needed for reading tag 64 on bags 24, which bags may be of differing sizes. For the Motorola system of RFID tags, the reader must be within about six inches of the tag 64.

If luggage is delivered to the passenger's address, and no one is home for delivery of the luggage and there is no locked luggage receptacle 42, the driver can leave a note at the destination indicating where to pick up the luggage or when to call the carrier for the next day's delivery, in a manner of standard operation for United Parcel Service and Federal Express. The particular destination of delivery of the luggage can be quite flexible, so if the passenger is not expected to be home, an alternate delivery site can be selected by the passenger.

Thus, a new system for airline passenger transportation is provided, resulting in substantial savings of cash and other advantages: of cash because the turnaround time of airliners can be greatly reduced, resulting in great financial savings, while the airliners will have substantial extra capacity for more passengers and express cargo for which a charge can be made. At the same time, much of the airline load (the baggage) which now flies from the congested central airports can either fly in the form of cargo planes in the small hours of the morning from the major airport, or from other airports at any time of day or night, to greatly reduce the congestion and difficulty involved in high-volume passenger air travel. The sharing of airplanes between airlines for their passenger travel is also facilitated, resulting in profitable alliances plus fewer flights without a loss of passenger mile capacity. The fewer flights of course, further reduce delays, further reducing heavy cost to the airlines.

The above has been offered for illustrative purposes only and is not intended to limit the scope of the invention of this application, which is as defined in the claims below.

That which is claimed is:

1. A method of providing passenger air travel, which comprises:
providing an airline flight reservation for a passenger and, simultaneously, providing a reservation for pickup of the passenger's luggage at a location remote from the airport from which the flight originates, said pickup reservation also specifying a luggage destination;
providing an airline flight for the passenger from said airport to a prearranged airport destination; and
providing transportation of said luggage by different transportation from said remote location to said luggage destination.

2. The method of claim 1 in which said luggage destination is remote from both said airport and said airport destination.

3. The method of claim 1 in which said different transportation is provided at least in part by an aircraft other than an aircraft that provides said airline flight.

4. The method of claim 1 in which said luggage transportation begins on the day prior to said airline flight.

5. The method of claim 1 in which said remote location comprises a lockable luggage container situated outside of a private home.

6. The method of claim 1 in which said different transportation comprises transport by a commercial, non-airline, package delivery company.

7. The method of claim 1 in which pieces of said luggage are labeled by attached radio frequency identification (RFID) chips.

8. The method of claim 1 in which said transportation of said luggage is provided at least in part by a vehicle capable of loading luggage in a random manner and unloading said luggage in a manner that is automatically sorted by destination or other characteristic.

9. The method of claim 1 in which the passenger is provided prior to the flight with a printed record of the flight reservation and the luggage pickup reservation, listing a tracking code for each piece of luggage.

10. The method of claim 10 in which a purchase is made of an item by the passenger; said purchase is assigned a tracking code at least related to the tracking code assigned to a said piece of luggage; and the item is delivered to said luggage destination.

11. A method of providing passenger air travel, which comprises:
providing an airline flight reservation for a passenger and, simultaneously, providing a reservation for pickup of the passenger's luggage at a location remote from the airport from which the flight originates, said pickup reservation also specifying a luggage destination;
providing an airline flight for the passenger from said airport to a pre-arranged airport destination; and
providing transportation of said luggage, by different transportation which is at least in part by an aircraft other than an aircraft that provides said airline flight, from said remote location to said luggage destination, said luggage destination being remote from both said airport and airport destination.

12. The method of claim 11 in which said luggage transportation begins prior to said airline flight.

13. The method of claim 11 in which said luggage destination comprises a lockable luggage container situated outside of a private home.

14. The method of claim 11 in which said different transportation comprises transport by a commercial, nonpassenger airline package delivery company.

15. The method of claim 11 in which pieces of said luggage are labeled by attached radio frequency identification (RFID) chips.

16. The method of claim 11 in which said transportation of said luggage is provided at least in part by a vehicle capable of loading luggage in a random manner and unloading said luggage in a manner that is automatically sorted by destination or other characteristic.

17. The method of claim 11 in which the passenger is provided prior to the flight with a printed record of the flight reservation and the luggage pickup reservation, listing a tracking code for each piece of luggage.

18. The method of claim 17 in which a purchase is made of an item by the passengers; said purchase being assigned a tracking code at least related to the tracking code of a said piece of luggage; and the item is delivered to said luggage destination.

19. The method of claim 11 in which a single price is charged by the airline for the passenger flight reservation and the luggage pickup reservation for delivery thereof to the luggage destination.

20. The method of claim 1 in which a single price is charged by the airline for the passenger flight reservation and the luggage pickup reservation for delivery thereof to the luggage destination.
